(19) United States
(12) Patent Application Publication
(10) Pub. No.: US 2015/0034630 A1
(43) Pub. Date: Feb. 5, 2015

(54) INDUCTION COOKING DEVICE FOR TEMPERATURE-CONTROLLED COOKING

(71) Applicant: Christian Fuchs, Buelach (CH)

(72) Inventor: Christian Fuchs, Buelach (CH)

(73) Assignee: INDUCS AG, Herisau (CH)

(21) Appl. No.: 13/979,583

(22) PCT Filed: Jan. 5, 2012
(86) PCT No.: PCT/CH2012/000003

§ 371 Date: Oct. 25, 2013

(30) Foreign Application Priority Data
Jan. 14, 2011 (CH) 64/11

(51) Int. Cl. A47J 36/24; H05B 6/12

(52) U.S. Cl. CPC A47J 36/2483; H05B 6/1245
USPC 219/667; 219/672; 99/483

(57) ABSTRACT

A modular heat-retaining system for keeping food warm. The system contains a plurality of induction heat retaining units, each of which forms a heat-retaining area, and further contains a common power and control unit having a common power controller and a plurality of connection interfaces for individually connecting and individually activating the induction heat-retaining units. In addition, the heat-retaining system contains one or more operating units, wherein the induction heat-retaining units contain at least one induction coil as part of an induction resonant circuit for generating an alternating magnetic field. The power and control unit contains control means for individual activation of the induction heat-retaining units.

### BACKGROUND

1. Field of the Disclosure

The disclosure lies in the field of heat-retaining systems for keeping food warm, in particular for gastronomy and for large-scale kitchens. For example, such heat-retaining systems are used in self-service buffets.

2. Discussion of the Background Art

Particular requirements are placed on heat-retaining systems, so that the quality of the food to be kept warm therein is maintained over a certain amount of time. Thus, for example, it is necessary that the temperature can be kept constant at a specific heat-retention level over a relatively long time period. Further, it is also important that the food be kept uniformly warm. Therefore, for example, not only the bottom, but also the side walls of containers in which the food will be kept warm, shall be heated uniformly. Thus, e.g., known solutions, such as find use in successful cooking, in which a plate is heated that in turn heats a dish placed on this plate via heat conduction, are not particularly well suitable. With these solutions, in fact, the bottom of the dish is heated, but the side walls are heated only via heat conduction within the dish and thus always have a basically lower temperature than the bottom of the dish.

Heat-retaining systems that comprise an appliance with one or more independent heat-retaining basins are known in the prior art. Each of the heat-retaining basins contains water, which is heated, e.g., via heating coils or heating plates. Heat-retaining tubs, e.g., which are made of steel and which hold the food, can then be introduced into the individual heat-retaining basins. Steam that surrounds the tubs and heats them is produced by heating the water. In this way, both the bottom and the side walls are heated by the surrounding steam. The described heat-retaining system has several disadvantages, however. Thus, the indirect heating of the tubs via the medium of steam leads to relatively high energy losses. Further, the system as such is inflexible and structurally complex. Such systems usually have a number of heat-retaining tubs fixed in place from the outset. A retrofitting of the appliance with additional heat-retaining basins is not possible. Therefore, in procuring such an appliance, care must always be taken that it has a sufficiently high capacity. However, if during use, not all of the heat-retaining basins are necessary, these can in fact be kept empty, but saving space due to the reduced operation does not result from this, since the heat-retaining basins cannot be separated from the appliance. Moreover, these systems have a relatively complex construction requiring high maintenance for personnel. Thus, the heat-retaining basins must be emptied and cleaned after each use. Further, the system contains heating coils or heating plates as well as inlet and outlet lines for the heat-retaining water, which also must be regularly maintained, e.g., decalcified. Since the water must always be heated first, before the heat-retaining tubs containing the food can be inserted into the basins, in addition, starting up the system takes a relatively long time.

Therefore, the object of the present disclosure is to create a heat-retaining system, which operates in a comparatively energy-efficient manner, requires less time for starting up, and is constructed modularly and capable of expansion, so that the size of the system can be individually adapted to its use in each case.

### SUMMARY

A modular heat-retaining system for keeping food warm contains:
a plurality of induction heat-retaining units, each of which forms a heat-retaining area;
a common power and control unit with a power controller and with a plurality of connection interfaces for individual connection and also, preferably, individual activation of the induction heat-retaining units.

Each of the induction heat-retaining units contains at least one induction coil as part of a resonant inductive circuit for generating an alternating magnetic field for purposes of heating a dish placed on the heat-retaining area. The heat-retaining area of an induction heat-retaining unit may contain one, two or more induction coils as part of a resonant inductive circuit for generating an alternating magnetic field for purposes of warming a dish placed on the heat-retaining area. If several induction coils are present, then these are connected in parallel. Further, the power and control unit preferably also contains control means for individually activating the induction heat-retaining units.

The power and control unit preferably has first connections for the individual power supply of each of the induction heat-retaining units via supply lines, as well as second connections for the individual data exchange via data lines to each of the induction heat-retaining units. The power and control unit as well as the individual induction heat-retaining units are also designed physically separate or independent of one another and are connected to one another, e.g., only via corresponding lines.

The induction heat-retaining units are connected via corresponding lines, e.g., star-shaped configuration, to the central power and control unit. The lines may be connection cables, for example. The connection cables and the connection interfaces belonging to them are preferably designed for detachable fastening of the cables. In this way, individual units can be connected to the power and control unit and can be disconnected from them again as desired, in the sense of modularity. The data lines can also be designed as wireless. The connection interfaces are represented in this case by transmitting and receiving units. Further, means for the automatic recognition of a newly connected unit are preferably provided. This can be accomplished, e.g., via corresponding programming means in the known “Plug and Play” mode.

The induction heat-retaining unit contains a support element having a top side, which serves as the bearing surface for the dish to be kept warm, and having a bottom side, which faces the induction coils. The support element is preferably composed of ceramics, glass, or glass ceramics, such as, e.g., Ceran glass. The support element is preferably designed as plate-shaped.

In a preferred embodiment of the disclosure, the induction heat-retaining unit contains at least one, preferably a plurality of temperature sensors, which measure the temperature of the support element on its bottom side, the sensors being distributed in the surface of the heat-retaining area, each sensor facing the bottom side of the support element. These sensors may be Pt temperature sensors, for example, in particular Pt 1000 temperature sensors. The power and control unit preferably contains corresponding evaluating means for evaluating temperature measurement data of the mentioned temperature sensors. The evaluating means may be part of the control means. The control of heat-retaining temperatures is described in detail below for the individual induction heat-retaining units. Each of the induction heat-retaining units may also contain means for recognizing a dish to be kept warm on the heat-retaining area. These means are known in the field of induction cooktops and thus will not be explained in further detail.

The heat-retaining system according to the disclosure preferably comprises means for controlling or regulating the temperature of the food or of the dish to be kept warm containing the food. For this purpose, the heat-retaining system contains temperature sensors, as described above. According to a preferred embodiment of the temperature control, the temperature sensors detect the temperature values of the temperature sensors either continuously or periodically and convey these values to the evaluating means.

The evaluating means compares the measured values to stored temperature reference values that correspond to the desired heat-retaining temperatures. When there is a deviation in the measured temperature to below the reference value, an electronic switch of the heat-retaining unit belonging thereto is switched via the control means, so that the resonant inductive circuit belonging thereto is provided with power and heat is introduced to the food stored in the dish to be kept warm by means of the thus-generated alternating magnetic field via the dish to be kept warm. As soon as the temperature has been sufficiently raised, the introduction of power is turned off again by a repeated switching of the electronic switch. The switching of the electronic switch can be conducted in almost any desired discrete time intervals. The shorter the switching intervals are, the more uniform is the temperature profile of the dish to be kept warm. The electronic switch will be explained in more detail below.

Since the temperature sensors directly measure the temperature of the support element on its bottom side and not the temperature of the bottom of the dish, when the temperature changes, for known reasons, the temperature response of the sensor lags behind the effective temperature of the bottom of the dish. This does not represent a big problem, however, in contrast to a temperature-controlled cooking process, since the primary goal here is to keep the temperature of the dish at a specific reference value, and frequent and striking temperature changes are generally not wanted, with the exception of when starting up the heat-retaining means. Furthermore, the delay in the temperature response for the temperature sensor can be taken into consideration by control technology via corresponding algorithms.

In addition, it can also be provided that the temperature of the dish to be kept warm is detected indirectly in the known way via an induction measuring coil.

As is known, the resonance frequency of the inductively stimulated dish to be kept warm can be determined via an induction measuring coil, which in turn is linearly dependent on the temperature of the dish to be kept warm. Now, if the function that forms the basis for this linear dependence is defined by temperature calibration values, then the actual temperature of the dish to be kept warm can be calculated directly from the determined resonance frequencies. The calibration values can be determined, e.g., by means of the above-described temperature sensors. This method is already known from the field of induction cooktops and can be applied here correspondingly. Instead of the above-named measured temperature values of the temperature sensors, the measured resonance frequencies or the temperature values calculated therefrom are now transmitted in a simple manner to the evaluation means.

The above-described method may also be used in connection with a retaining function, in which the user targets the system to maintain a temperature that has been reached by means of a corresponding input, e.g., during the heating-up process. In this case, in fact, a temperature calibration can be dispensed with, since the user activates the retaining function when the desired temperature is reached, and the system only needs to maintain the actual resonance frequency at the activation time point via a regulation mechanism without the system needing to know the absolute temperature of the dish to be kept warm that lies at the basis of this frequency.

As already mentioned, preferably several temperature sensors distributed over the heat-retaining area are provided. Such an arrangement takes into account the fact that the dish to be kept warm can be smaller than the heat-retaining area, and therefore the dish covers only a partial region of the heat-retaining area. In such a case, however, at least one of the temperature sensors lies underneath the dish to be kept warm and thus also detects the heat-retaining temperature thereof. By means of corresponding control means, the corresponding temperature sensor, which actually measures, identifies and selects a heat-retaining temperature and its measured temperature values can be used for regulating the heat-retaining temperature.

The heat-retaining temperature is preferably regulated via the control means of the power and control unit. This takes into account the philosophy that forms the basis for the heat-retaining system according to the disclosure, that as many tasks as possible of the heat-retaining system will be combined centrally in the power and control unit. In this case, the measured temperature values or the initial values detected for calculating the temperatures are transmitted over the data lines to the power and control unit. Control commands, e.g., for switching the electronic switches, are also transmitted via the data line, as long as these are not accommodated in the power and control unit. The actual values for the measured temperature values can be indicated on a display via the display unit described below. Further, the reference temperature values can be input by the user by means of the input unit also described below.

The control means of the power and control unit are preferably designed for the individual or zone-wise regulation of the heat-retaining temperatures of the induction heat-retaining units. Zone-wise means that several induction heat-retaining units form, by control technology, a common heat-retaining zone, in which the units belonging thereto are regulated at the same heat-retaining temperature.

The heat-retaining system preferably contains at least one display and/or input unit for the display of parameters, such as, e.g., actual heat-retaining temperature, reference temperature, etc. and/or for the input of data, such as control commands, e.g., switching an induction heat-retaining unit on or off, or of parameters, such as reference temperature, heat-retaining time, etc. The at-least one display and/or input unit, however, is preferably disposed in the region of the heat-retaining system. If only one display and/or input unit is provided, then this can be integrated physically in the power and control unit or can be designed as physically independent. It can also be provided that additionally or alternatively to the above-named arrangement, each heat-retaining unit has its own display and/or input unit, e.g., for the local display of the heat-retaining temperature. For example, this unit is integrated into the respective heat-retaining unit.

Furthermore, one or more operating units, by means of which the induction heat-retaining units can be individually turned on or off by the user, can be provided. Preferably, a separate operating unit is provided for each induction heat-retaining unit. In particular, the operating unit comprises a switch. The operating units can be designed as physically independent or can be integrated physically in the power and control unit or the display and/or input unit or in the individual induction heat-retaining units.

In an enhancement of the disclosure, it can contain a central display and/or input means for the display of indicators, such as actual heat-retaining temperature of the individual induction heat-retaining units, status of the induction heat-retaining units, etc., and/or for the input of control data, such as turning heat-retaining units on or off or for the input of reference temperatures. The display and/or input means, as also all physically independently designed display and/or input units, is connected to the power and control unit via a corresponding data line, e.g., via a data bus, such as a CAN bus, and connection interfaces. The display and/or input means comprises, e.g., a display and a microprocessor. For example, it can be a conventional computer. The display and/or input means is characterized in that it is not disposed in the region of the heat-retaining system, but rather can be found in another space, for example. The display and/or input means thus permits the monitoring of the heat-retaining system from another site. The display and/or input means may additionally be provided for at least one display and/or input unit or correspond to the latter.

In an enhancement of the disclosure, the power and control unit or its power controller contains:
a mains connection, for supplying the power controller with mains a.c. voltage;
a rectifier for generating a d.c. voltage from the mains a.c. voltage;
a common d.c. voltage intermediate circuit for supplying a common power stage; and
a common power stage by means of which the induction heat-retaining units are supplied with power in a specified switching frequency.

The power stage can be activated via control means, e.g., the power and control unit. In the connection to the power stage, i.e., between the power stage in the power and control unit and the one or more induction coils in the induction heat-retaining units, there is provided for each induction heat-retaining unit, as has already been mentioned, an electronic switch for the individual connecting or disconnecting of the power supply to the induction coils of the induction heat-retaining units. The electronic switch can be a relay, such as a semiconductor relay, or a transistor. The electronic switches are preferably also contained in the power and control unit. The switches may also be disposed, however, in the individual induction heat-retaining units.

Additionally, each resonant inductive circuit can also contain a variable switching element, such as, e.g., a controllable inductor, by means of which the output power of the resonant circuit to the dish to be kept warm can be controlled. Such an inductor is d.c.-controlled, for example. The variable switching element is disposed, e.g., in each induction heat-retaining unit. This type of variable switching element is described, e.g., in the Swiss Patent Application No. 00652/10 of Apr. 30, 2010.

The power stage can be supplied, for example, with 300 V d.c. from a d.c. intermediate circuit. The power stage is designed, e.g., for the output of a total power of 3200 W. These 3200 W are divided into four connected heat-retaining units with a power of 800 W per heat-retaining unit. Means that control the power output of the power stage as a function of the number of connected induction heat-retaining units, on the one hand, and, on the other hand, that regulate the power input as a function of the respective switching states of the individual electronic switches assigned to the devices can be provided in the power and control unit.

The disclosure also relates to a power and control unit suitable for use in a modular induction heat-retaining system or induction heat-retaining appliance as described above. The power and control unit contains a common power controller and a plurality of connection interfaces for the individual connection and the individual activation of induction heat-retaining units, as described above and below.

The disclosure further relates to an induction heat-retaining unit suitable for use in a modular induction heat-retaining system, such as described above. The induction heat-retaining unit forms a heat-retaining area, which contains at least one induction coil as part of a resonant inductive circuit for generating an alternating magnetic field for the purpose of warming a dish placed on the heat-retaining area. The induction heat-retaining unit has a connection interface for the connection of a power and control unit of the above-described type.

Correspondingly suitable dishes to be kept warm with ferromagnetic properties are to be used for a friction-free functioning of the heat-retaining system according to the disclosure. The dish to be kept warm is to be designed corresponding to the heat-retaining system according to the disclosure and thus also can be considered as part of the heat-retaining system. A preferred dish to be kept warm is composed of coated aluminum, in particular cast aluminum. The casting process can be, e.g., a die-casting method. The aluminum base is coated partially or completely, at least on its outer surface. The coating is particularly applied in the support region, i.e., on the bottom of the dish. The coating comprises components with ferromagnetic properties, so that the aluminum material that is less suitable for induction applications can also be used for this application. The good heat conductivity of the aluminum assures an optimal input of heat into the food.

### BRIEF DESCRIPTION OF THE DRAWINGS

In the following, the subject of the disclosure is explained in further detail based on preferred examples of embodiment, which are shown in the appended figures.

### Herein:

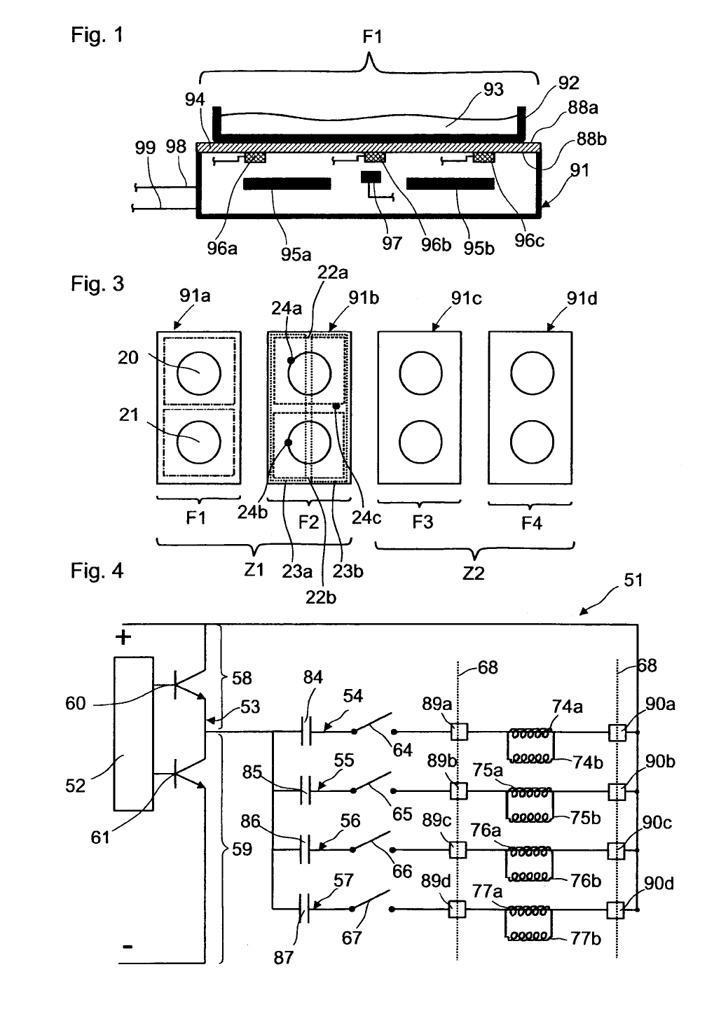

FIG. 1 shows a schematic representation of an induction heat-retaining unit according to the disclosure;

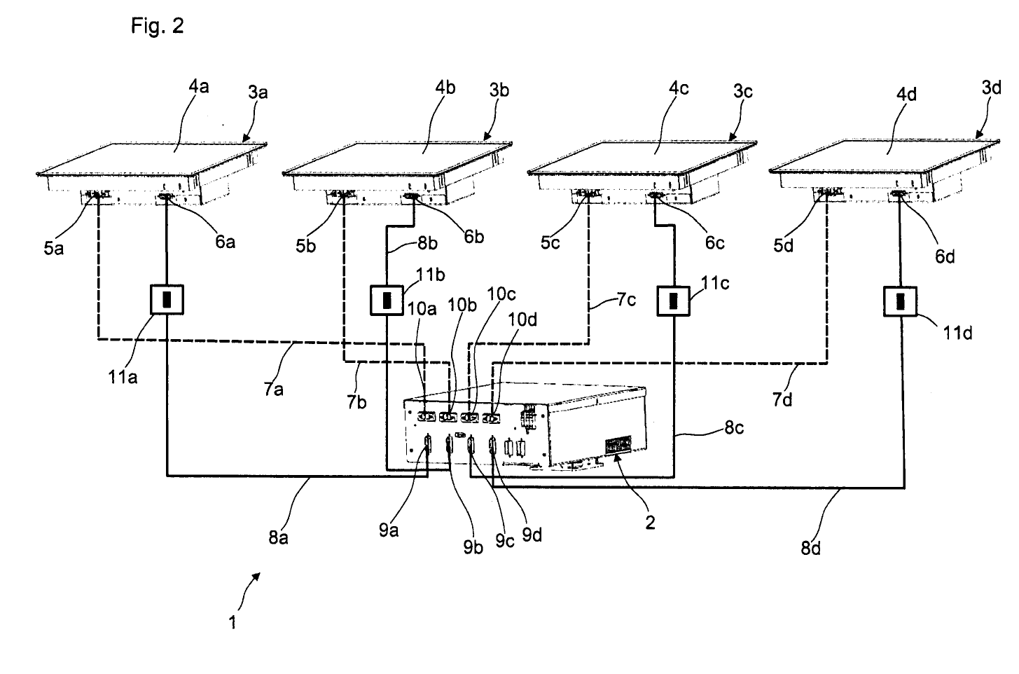

FIG. 2 shows a schematic representation of an induction heat-retaining system according to the disclosure;

FIG. 3 shows a schematic arrangement of induction heat-retaining units according to the disclosure in top view;

FIG. 4 shows a circuit arrangement of an induction heat-retaining system according to the disclosure.

### DETAILED DESCRIPTION OF THE PREFERRED EMBODIMENT

The reference numbers used in the drawings and their meaning are compiled in the List of Reference Numbers. Basically, the same parts are provided with the same reference numbers in the figures.

FIG. 1 shows one possible embodiment of an induction heat-retaining unit 91. This unit can be connected via a supply line 98 to the power stage of a central power and control unit. Further, the induction heat-retaining unit has a data line 99, by means of which the device 91 can also be connected to the central power and control unit. The arrangement of induction heat-retaining units and the power and control unit will be explained in more detail below relative to FIG. 2.

The induction heat-retaining unit 91 comprises an electronics assembly with two induction coils 95a . . . b disposed next to one another in the present embodiment. Since the heat-retaining area (see also FIG. 3) is rectangular, a more uniform heat input into the dish to be kept warm 92 is achieved with two induction coils 95a . . . b. The induction heat-retaining unit 91 contains a planar support element 94, which is, e.g., a Ceran glass plate. A rectangular heat-retaining area F1 is formed on its top side 88a. The heat-retaining area F1 defines the use surface, which can be allocated for keeping food 93 warm with dish 92 to be kept warm. The induction heat-retaining device 91 forms a heat-retaining area F1. Since the induction heat-retaining units 91, 91a, 91b, 91c, 91d according to FIGS. 1 and 3 are designed rectangular in shape with two induction coils 95a, 95b; 20, 21, larger, rectangular containers, which cover the entire heat-retaining area F1 and thus extend over both induction coils 95a, 95b; 20, 21, can be used. On the other hand, however, smaller containers, which cover only approximately half of the heat-retaining area F1 are provided with heating power via one of the two induction coils.

Three temperature sensors 96a . . . c; 24a . . . c, which are distributed over the heat-retaining area, are introduced on the bottom side 88b of the support element 94. These sensors measure the temperature of the bottom side 88b of the support element 94. Optionally, a measuring instrument with an induction measuring coil 97 can be provided, by means of which the resonance frequency of the dish to be kept warm 92 belonging thereto can be determined for purposes of temperature control, as explained further above.

An embodiment of a modular induction heat-retaining system 1 according to the disclosure is shown in FIG. 2. The heat-retaining system 1 comprises a common power and control unit 2 as well as four induction heat-retaining units 3a . . . d operated via the power and control unit 2. Each induction heat-retaining unit 3a . . . d forms a heat-retaining area 4a . . . b, which is bounded, for example, by a support element, such as a Ceran glass plate. The power and control unit 2 contains four connection interfaces 10a . . . d for supply lines 7a . . . d as well as four connection interfaces 9a . . . d for data lines 8a . . . d. The data lines 8a . . . d can be serial connections, e.g., data bus connections. The individual induction heat-retaining units 3a . . . d also contain corresponding connection interfaces 5a . . . d for the supply lines 7a . . . d for the power supply as well as connection interfaces 6a . . . d for the data lines 8a . . . d for data transmission. Each connected induction heat-retaining unit 3a . . . d can be connected or disconnected individually by the user via a switch 11a . . . d assigned to it. The switches 11a . . . d can be designed physically independent from the power and control unit 2 or they can be integrated in the power and control unit 2. Basically, the system according to the disclosure preferably contains a display and/or input unit (not shown), by means of which data, such as reference temperature values or control commands, can be input and/or displayed. The switches can be integrated into the display and/or input unit, so that the induction heat-retaining units can be individually turned on and off by these switches. The display and/or input unit may contain a display, for example. The display and/or input unit can be physically integrated into the power and control unit or can be physically independent from it. The display and/or input unit is connected to the power and control unit via a data line. The power and control unit can be controlled, configured, and/or supplied with parameters, such as reference temperatures, heat-retaining times, etc., by the user, preferably via the display and/or input unit.

The power supply line and the data line do not necessarily need to be introduced via separate lines and connection interfaces. They may also be combined physically for each induction heat-retaining unit in a common line system and/or in a common plug-in connection. Further, the power and control unit can also have more than or less than four, but preferably two or more connection interfaces for induction heat-retaining units.

Correspondingly, more than or less than four, but preferably two or more induction heat-retaining units corresponding to the number of connection interfaces can also be connected to the power and control unit. Of course, not all connection interfaces need to be occupied. That is, fewer induction heat-retaining units may be connected than the connection interfaces possessed by the power and control unit. This represents a great advantage of the modular system according to the disclosure. Only that number of induction heat-retaining units that are actually required, e.g., for a buffet operation, need to be connected. In this way, valuable space can be saved because there is no unutilized heat-retention capacity in the buffet area.

The induction heat-retaining units 3a . . . d, the power and control unit 2, as well as the switches 11a . . . d and the display and/or input unit can be incorporated into a self-contained appliance unit, which is configured, e.g., as furniture, such as a cabinet. The heat-retaining system according to the disclosure in general has a high flexibility in the configuration of a buffet and represents a relatively simple solution for installation. Of course, the heat-retaining system can also be designed as a stand-alone solution.

In FIG. 3, a schematic arrangement of four induction heat-retaining units 91a . . . d are shown, which are supplied with power and activated by a common power and control unit (not shown). As explained above, each induction heat-retaining unit 91a . . . d forms a heat-retaining area F1, F2, F3, F4 (depicted as rectangular here), each area being supplied with heating power via two induction coils 20, 21 (depicted explicitly only in area F1 here). The induction coils 20, 21 in the present example are round, i.e., circular in shape. However, they can be formed also as rectangular and particularly as both rectangular and covering the entire surface. That is, the coils are particularly adapted to the shape of the heat-retaining area. For example, they can be formed as square. In the heat-retaining area F1 of FIG. 3, such a rectangular coil is depicted by a broken line for purposes of illustration. The above embodiments for the shape of the coil, of course, are not limited to the present example of embodiment.

In the present example, every two induction heat-retaining units 91a . . . b; 91c . . . d form a common heat-retaining zone Z1 or Z2. A heat-retaining zone Z1 or Z2 is characterized in that all heat-retaining areas F1, F2 or F3, F4, which belong to this zone Z1 or Z2, are controlled at the same heat-retaining temperature. The food or the dishes to be kept warm in one heat-retaining zone are thus regulated at the same temperature. The present embodiment example according to FIG. 3 thus offers two heat-retaining zones Z1, Z2 with two different heat-retaining temperatures.

The induction heat-retaining unit 91b further shows one possible distribution of three temperature sensors 24a . . . c over the heat-retaining area. The three temperature sensors 24a . . . c in the present example are distributed in a triangle formation. The triangle is thus placed in the heat-retaining area so that if the rectangular area is divided into two halves in the longitudinal direction or divided into two halves crosswise thereto, at least one temperature sensor 24a . . . c always lies in one of the area halves. Thus, a dish to be kept warm can be used which occupies only one half of the area, e.g., in longitudinal direction (see dish 23a . . . b), or occupies only half of the area in the crosswise direction (see dish 22a . . . b). Independent of the concrete number and arrangement of the temperature sensors, it is important that at least one temperature sensor lies in one of the area halves for each of the above-named divisions into two halves.

FIG. 4 shows an embodiment of a circuit arrangement 51 for an induction heat-retaining system according to the disclosure with a common power controller and several induction heat-retaining units. The induction heat-retaining units receive their power from a common, central power stage 53. The power stage 53 comprises two bridge arms 58, 59. Each bridge arm 58 or 59 contains one transistor and a freewheeling diode assigned to it, each time commonly designated by 60 or 61. Not depicted is a d.c. voltage source, typically a rectifier circuit, which supplies the bridge circuit. The individual electronics 54, 55, 56, 57 of the resonant inductive circuit for the individual heat-retaining units are supplied via the same bridge circuit with a uniform switching frequency. For purposes of turning on and off the electronics 54, 55, 56, 57 of the resonant inductive circuit for the individual heat-retaining units, each electronics 54, 55, 56, 57 of the inductive resonant circuit is assigned an electronic switch 64, 65, 66, 67, in particular a relay, between the induction coils 74a, 74b; 75a, 75b; 76a, 76b; 77a, 77b and the power stage 53. Although all induction heat-retaining units are supplied over a common power stage with uniform switching frequency, these units can now be turned on or off individually by means of electronic switches 64, 65, 66, 67, as needed, i.e., depending on whether heating power is necessary.

In the present embodiment, each of the electronics 54, 55, 56, 57 of the resonant inductive circuit comprises two induction coils, by means of which the heat-retaining area of the induction heat-retaining unit can be supplied with heating power. Of course, also only one or more than two induction coils can be provided per heat-retaining area or per resonant inductive circuit. In each case, the capacity 84, 85, 86, 87 of the resonant circuit belonging thereto is disposed between the power stage and the electronic switch. This capacity, however, can also be disposed in another place, e.g., between the relay and the induction coils.

The circuit arrangement 51 is physically divided on the power controller or the power unit and the individual induction heat-retaining units. In the present example of embodiment, the line 68 schematically represents the separation between power unit and the induction heat-retaining units The separation is shown by the also schematically represented connection interfaces 89a . . . d and 90a . . . d. The power unit also contains here, in addition to the power stage 53, the capacities 84 . . . 87, as well as the electronic switches 64 . . . 67. The electronics are reduced to a minimum in the induction heat-retaining units. Of course, the capacities 84 . . . 87 and/or the electronic switches 64 . . . 67 can also be accommodated in the induction heat-retaining unit belonging thereto. Further, the polarity of the connections may also be reversed.

### LIST OF REFERENCE NUMBERS

1 Induction heat-retaining system
2 Power and control unit
3a Induction heat-retaining unit
4a . . . d Support element
5a . . . d Connection interfaces for the supply lines
6a . . . d Connection interfaces for the data lines
7a . . . d Supply lines
8a . . . d Data lines
9a . . . d Connection interfaces for the data lines
10a . . . d Connection interfaces for the supply lines
11a . . . d Switching units
20 Resonant circuit with induction coil
21 Resonant circuit with induction coil
22a . . . b Dishes to be kept warm
23a . . . b Dishes to be kept warm
24a . . . c Temperature sensors
51 Circuit arrangement
52 Control means
53 Power stage with power switch (power transistor)
54 Electronics of the resonant inductive circuit of the first heat-retaining area F1
55 Electronics of the resonant inductive circuit of the second heat-retaining area F2
56 Electronics of the resonant inductive circuit of the third heat-retaining area F3
57 Electronics of the resonant inductive circuit of the fourth heat-retaining area F4
58 First bridge arm
59 Second bridge arm
60 Transistor with freewheeling diode
61 Transistor with freewheeling diode
64 Electronic switch (transistor, relay)
65 Electronic switch (transistor, relay)
66 Electronic switch (transistor, relay)
67 Electronic switch (transistor, relay)
68a . . . b Line for the physical separation between power unit and induction heat-retaining units
74a First resonant circuit with induction coil
74b Second resonant circuit with induction coil
75a First resonant circuit with induction coil
75b Second resonant circuit with induction coil
76a First resonant circuit with induction coil
76b Second resonant circuit with induction coil
77a First resonant circuit with induction coil
77b Second resonant circuit with induction coil
84 Capacity of the resonant inductive circuit
85 Capacity of the resonant inductive circuit
86 Capacity of the resonant inductive circuit
87 Capacity of the resonant inductive circuit
88a Top side
88b Bottom side
89a . . . d Connection terminals
90a . . . d Connection terminals
91 Induction heat-retaining unit
92 Dish to be kept warm
93 Food
94 Support element
95a . . . b Induction coil of a resonant inductive circuit
96a . . . c Temperature sensors
97 Measuring resonant circuit with induction measuring coil
98 Supply line
99 Data line
F1 Heat-retaining area 1
F2 Heat-retaining area 2
F3 Heat-retaining area 3
F4 Heat-retaining area 4
Z1 Temperature zone 1
Z2 Temperature zone 2

What is claimed is:

1. A modular heat-retaining system for keeping food warm comprising:
a plurality of induction heat-retaining units, each of which forms a heat-retaining area;
a common power and control unit having a common power controller and having a plurality of connection interfaces for the individual connection of the induction heat-retaining units,
wherein each of the induction heat-retaining units contains at least one induction coil as part of a resonant inductive circuit for generating an alternating magnetic field for purposes of heating a dish to be kept warm placed on the heat-retaining area.

2. The modular heat-retaining system according to claim 1, wherein the power and control unit contains first connections for the individual power supply for each of the induction heat-retaining units, as well as second connections for the individual data exchange with each of the induction heat-retaining units.

3. The modular heat-retaining system according to claim 2, wherein the first and/or second connections are designed on the power and control unit for the detachable introduction of connection cables for the connection to the induction heat-retaining units.

4. The modular heat-retaining system according to claim 3, wherein the induction heat-retaining unit forms a support element having a top side, which serves as the bearing surface for the dish to be kept warm, and a bottom side, which is facing the induction coil.

5. The modular heat-retaining system according to claim 3, wherein each of the heat-retaining units contains at least one, which is distributed in the surface of the heat-retaining area, each one facing the bottom side of the support element, for measuring the temperature of the support element on its bottom side.

6. The modular heat-retaining system according to claim 1, wherein the power and control unit evaluates temperature measurement data of the temperature sensors on the induction heat-retaining units.

7. The modular heat-retaining system according to claim 1, wherein the power and control unit comprising a controller that regulates the heat-retaining temperatures on the induction heat-retaining units.

8. The modular heat-retaining system according to claim 1, wherein the heat-retaining system comprises at least one central display and/or inputs for the connected induction heat-retaining units for the display of indicators of the individual induction heat-retaining units.

9. The modular heat-retaining system according to claim 8, wherein the power and control unit comprises a connection interface for producing a data connection to a physically independently formed central display and/or inputs.

10. The modular heat-retaining system according to claim 7, wherein the power and control unit or its power controller comprise:
a mains connection that supplies the power controller with mains a.c. voltage;
a rectifier that generates a d.c. voltage from the mains a.c. voltage;
a common d.c. voltage intermediate circuit that supplies common power stage; and
a common power stage that can be activated via said controller, and by means of which the induction heat-retaining units are supplied with power.

11. The modular heat-retaining system according to claim 1, wherein the power and control unit (2) or its power controller contains a power stage, and a plurality of electronic switches which are connected to said power stage for the individual connection or disconnection of the power supply to the induction coils of the induction heat-retaining units.

12. The modular heat-retaining system according to claim 11, wherein each of the induction heat-retaining units has an electronic switch for the individual connection or disconnection of the power supply from the power stage to the induction coil.

13. The modular heat-retaining system according to claim 1, wherein the heat-retaining area comprises at least one induction heat-retaining unit and two or more induction coils as part of a resonant inductive circuit for generating an alternating magnetic field for warming a dish placed on the heat-retaining area, the induction coils being connected in parallel.

14. A power and control unit, suitable for application in a modular heat-retaining system comprising a power and control unit comprising a common power controller and a plurality of connection interfaces for individual connection and the individual activation of induction heat-retaining units.

15. An induction heat-retaining unit, suitable for application in a modular heat-retaining system according to claim 1, wherein the induction heat-retaining unit forms a heat-retaining area, and comprises at least one induction coil as part of a resonant inductive circuit for generating an alternating magnetic field for purposes of warming a dish placed on the heat-retaining area, and wherein the induction heat-retaining unit has a connection interface for the connection to a power and control unit having a common power controller.
